(19) United States
(12) Patent Application Publication
(10) Pub. No.: US 2001/0047412 A1
(43) Pub. Date: Nov. 29, 2001

(54) Method and apparatus for maximizing distance of data mirrors

(76) Inventor: Joseph B. Weinman JR., Basking Ridge, NJ (US)

Correspondence Address: Mr. S. H. Dworetsky, AT&T Corp., P.O. Box 4110, Middletown, NJ, 07748, US

(21) Appl. No.: 09/828,869

(22) Filed: Apr. 10, 2001

Related U.S. Application Data
(60) Provisional application No. 60/202,661, filed on May 8, 2000.

(51) Int. Cl. G06F 15/173

(52) U.S. Cl. 709/225; 709/219

(57) ABSTRACT

The invention is a method and apparatus for mirroring and relaying computer data to improve continuity of data by maximizing the distance between two copies of the data in synchronous mode, zero data loss environments. In one embodiment, the invention uses multiple remote mirror sites to increase the distance of one copy of mirrored data from another copy of mirrored data. In another embodiment, the invention uses relays in a wide-area cascade to increase the distance of a remote mirror site from a server sending write requests. This is done without affecting system performance by allowing the server to continue performance when an acknowledgment is received from the first relay, without waiting for an acknowledgment from the remote mirror site.

This application claims the benefit of U.S. Provisional Application No. 60/202,661, filed May 8, 2000, herein incorporated by reference

### FIELD OF THE INVENTION

The present invention relates to the field of computer data. More specifically, the invention is a method and apparatus for mirroring and relaying computer data to improve data availability in the event of an outage or disaster by maximizing the distance between two exact copies of a current version of the data.

### BACKGROUND OF THE INVENTION

Our society is increasingly dependent up information technology to function, and as a result it is increasingly a customer and regulatory requirement that data be 1) available at all times, 2) accurate, and 3) timely and current.

For instance, credit card companies must be able to confirm a consumer's account information before authorizing a purchase, stock brokerages cannot lose data associated with trades, banks must always maintain accurate account balance information, and Internet service providers must be able to access their user databases to confirm a user's login ID and password before access is granted to the user. If the credit card company cannot access their users' account information, they cannot authorize purchases, and thus lose money. If the stock broker loses information concerning trades, they not only would have a disgruntled customer, but might be subject to arbitration, a lawsuit, and/or actions and penalties from the Securities and Exchange Commission or the Comptroller of the Currency. If the Internet service provider cannot confirm a user's login ID and password, the user will not be allowed on the system, resulting in disgruntled users.

To meet these requirements for availability, accuracy, and currency, organizations typically try to utilize high reliability components and systems to access and maintain data. However, even a system that is inherently 100% reliable, e.g., in terms of its electronic or electro-optical function, is susceptible to a local disaster due to a power outage, fire, flood, tornado, or the like. To limit data loss, organizations have typically made back-up copies of their data onto tape, e.g., Digital Linear Tape, and then store that tape off-site. There are numerous problems with this approach, however. For example, the database may need to be quiesced while a backup is being made, limiting the availability of the application that is creating, modifying or using the data. Even worse, however, in the event of a loss of primary data, the backed up data is only as recent as the last backup, which may be hours or days. Such lack of currency may be unacceptable, e.g., for financial transactions. In addition, time and manpower are required to load the data onto a spare disk array or set of storage devices from the backup tape or other backup mechanism.

To combat problems and deficiencies of tape backups listed above, such as time to restore, currency of data, and availability of data and applications, organizations are maintaining multiple real-time copies of their data on two or more independent physical storage devices, sometimes called HDDs (Hard Disk Drives) or HDAs, (Hard Disk Assemblies, or Hard Drive Assemblies). An HDA is typically, but not limited to, a sealed assembly which contains a physical magnetic disk on which the data is written, a movable head, which actually writes the data, and associated control circuitry. These HDAs are typically configured into arrays, called RAID, or Redundant Array of Independent Disks. A variety of RAID schemes exist as are known in the art, including striping, in which contiguous data is written across multiple disks, parity, in which a checksum is written as well as the data, and mirroring, in which an exact copy of the data is written to at least two separate physical disks. Data mirroring within a disk array effectively combats against failure of one of the HDA's components in an array or group of storage arrays, such as when a hard disk “crashes”. That is, if one hard disk crashes, the system automatically switches to the remaining hard disk without any service interruption. However, if a local or regional disaster, such as a tornado, flood, or fire, hits the storage facility, and both storage devices are located within the facility, then the data could still be completely destroyed.

To ensure continuity and availability of data, i.e., the ability of data to survive a local or regional physical disaster and be available for use, organizations mirror data to remote geographic locations through remote mirroring, wherein at least one copy of the data exists in one location, and an exact copy of the data exists in another location physically separate from the first to make it unlikely that a physical disaster would simultaneously affect both (or more) copies of the data. Examples of products and techniques from vendors such as IBM, EMC, StorageTek, HP, and Hitachi include Peer-to-Peer Remote Copy, Symmetrix Remote Data Facility, XRC, HARC, NanoCopy, etc. These use a variety of approaches, including synchronous mode storage subsystem level communications protocols. Some of these systems, such as IBM's Geographically Dispersed Parallel Sysplex architecture, involve more than the storage subsystem, and involve system timers and server timestamps. Synchronous mode storage subsystem level remote mirroring has two key characteristics. First, it is synchronous: i.e., when a server requests that a disk array write data, before the disk array acknowledges such a write back to the server, it communicates the data to its remote mirror, ensures that the write has been conducted by the remote device via an acknowledgement from that mirror, and then and only then acknowledges the write back to the requesting server. Second, it occurs at the storage subsystem level, i.e., disk controllers communicate with each other, typically across a Storage Area Network and/or Metropolitan Area Network, without the server's awareness.

The techniques used in the prior art have a variety of limitations, but fundamentally there has heretofore been a need to trade off distance of the remote mirror (and therefore latency of the network used to communicate between locations) with either currency of the mirrored copy of the data and/or processor and application performance. For example, some techniques permit unlimited distance between locations. However, it takes time to copy data remotely, due to a variety of factors. First is the signal propagation delay, e.g., light in a vacuum takes roughly 5 microseconds to cover a mile, various optical and electromagnetic communications methods take longer. Second is the serial transmission rate, e.g., the last bit arrives some time after the first bit. Third are delays due to encryption, data compression, and the like. Fourth is the fact that an acknowledgement signal may need to be returned. Due to these delays, the system designer or integrator needs to make a choice: either let the application and server keep processing without waiting for an acknowledgement, which risks loss of committed transactions in the event that the primary site suffers an outage or disaster, or wait for the acknowledgement, which can severely impair the performance, throughput, and/or response time of the application as it repeatedly waits for acknowledgement that the remote copy has been recorded. In the typical situation where the system developer/integrator is unwilling to risk data loss, and unwilling to impair application performance, distance limitations, typically of about twenty-five miles in today's computing and network environments, apply. Further, as CPU and disk I/O speeds increase, the geographic distance in which a remote mirror will not impact performance is decreasing. Also, if a local or regional disaster of at least twenty-five miles, such as an earthquake, affects both storage locations, all of the data may still become lost or unavailable. It is also possible that a “rolling disaster”, such as a flood, may damage assorted system components serially, causing data loss or corruption in one or more data mirroring locations, thus damaging data integrity. Finally, in real-world implementations, companies may have multiple sites where they already house data processing operations. However, these sites may not be located within 25 miles of each other, and companies may wish to take advantage of remote mirroring technology while also leveraging their existing investment in conditioned facilities and not incurring the costs involved in site selection, construction, and data center migration.

It would be an advancement in the art if storage facilities which maintain synchronized copies of data could be located more than twenty-five miles apart without affecting system performance.

It would be another advancement in the art if system integrity remained stable in the face of a rolling disaster.

### BRIEF SUMMARY OF THE INVENTION

[Ross to Finalize After Claims]

The invention is a method and apparatus for mirroring and relaying computer data to improve continuity and availability of data by maximizing the distance between two copies of the data in synchronous mode, zero data loss environments. The present invention provides the means to extend the distance by which remote mirroring sites are located by changing the fundamental architecture of remotely mirrored storage systems from a local storage subsystem cooperating with a remote storage subsystem, to a local controller cooperating with two or more remote storage subsystems.

In one embodiment, the invention uses multiple remote mirror sites to increase the separation distance of one copy of mirrored data from another copy of mirrored data. A local site houses a server and a bipolar mirror controller. At least two remote sites each contain a disk array controller, a cache, and storage devices such as high-density disk drives. After receiving a write request from the server, the bipolar mirror controller sends the request to each of the remote mirror sites, which then perform the write request at each location. Each mirror site then sends an acknowledgment back to the bipolar mirror controller, which in turn sends a single acknowledgment back to the server. The server then continues normal operation. Each remote site is approximately at least twenty-five miles from the local site. Thus, if the remote sites are substantially diametrically opposed to each other from the local site, the remote mirrors can be located at least fifty miles apart.

In another embodiment, the invention uses relays in a wide-area cascade to increase the distance of a remote mirror site from a server without affecting system performance. The cascade is made of multiple relays between the local and remote sites. The server is located at a primary site, as is a local disk array controller. The server sends write requests to the local disk array controller (DAC). The local DAC writes the request to its cache, and forwards the request to the first relay in the cascade. Upon receiving the request, the first relay writes the request to its cache, sends the request to the next relay, and sends an acknowledgement back to the sender of the original request. The next relay performs the same sequence of events, until the last relay forwards the request to the remote mirror site. The remote mirror site then writes the request and sends an acknowledgement to the final relay. Any number of relays may be used in order to achieve the desired distance of the mirror site from the local site. As soon as the local DAC receives an acknowledgment from the first relay, the local DAC sends an acknowledgment to the server. The server then continues normal operations without an extended wait for the acknowledgment from the remote mirror site.

In a variation, diverse routes (and therefore, cascades) can be used to connect the local site with the remote mirror, so that no single point of network segment failure or relay failure will impact the ability of the overall system to maintain widely separated, synchronized copies of the data.

### BRIEF DESCRIPTION OF THE DRAWINGS

FIG. 1 depicts a synchronous mode remote mirroring architecture;

FIG. 2 depicts a synchronous mode remote mirroring method;

FIG. 3 depicts a bipolar synchronous mode data mirroring architecture;

FIG. 4 depicts a bipolar synchronous mode data mirroring method;

FIG. 5 depicts a dual ported bipolar server and synchronous mode data mirror architecture; and

FIG. 6 depicts a wide-area storage cascade synchronous data mirroring architecture.

FIG. 7 depicts an alternative embodiment of a bipolar synchronous mode data mirroring architecture.

### DETAILED DESCRIPTION OF THE INVENTION

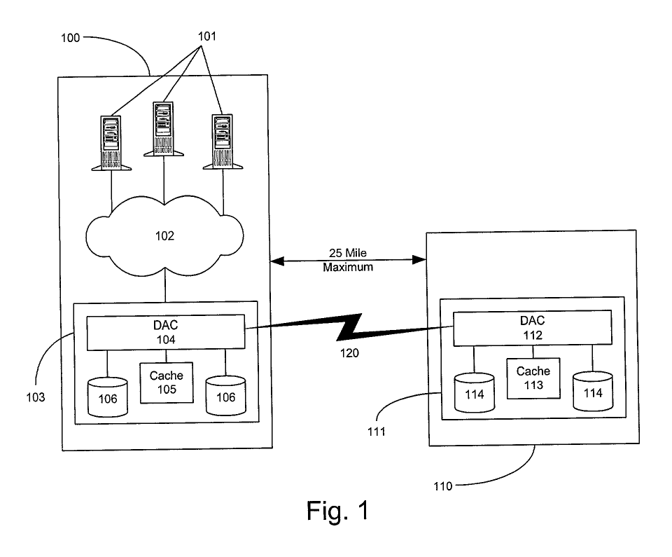

The invention will now be described with reference to FIGS. 1-7. FIG. 1 depicts a conventional synchronous mode remote mirroring architecture. In FIG. 1, at a local storage site 100, one or more servers 101 are connected to a local storage subsystem 103, possibly through an optional storage area network (SAN) 102. The storage subsystem 103 further includes a disk array controller 104, cache 105, high-density memory storage device(s) 106 (HDDs), such as conventional hard-disk drives. At a remote mirror site 110, located approximately twenty-five miles away, a remote storage subsystem 111 includes a disk array controller 112, cache 113, and HDDs 114. The disk array controller 112 is connected to the local storage subsystem 103, and more particularly to the disk array controller 104, by network 120. Typically, such an architecture would be used in combination with other components (not shown) such as network equipment, such as IP routers or fiber channel extenders, a management and monitoring infrastructure, failover servers at the remote site, front-end networks and load balancing devices, etc.

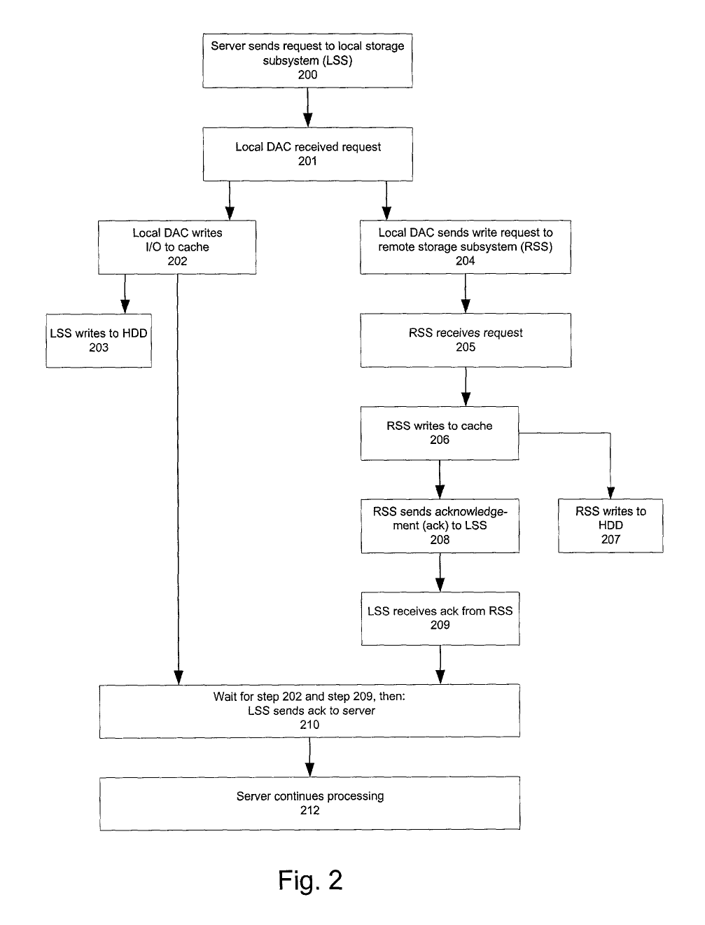

FIG. 2 shows a conventional synchronous mode remote mirroring method. In step 200, one of the server(s) 101 sends a write I/O request to the local storage subsystem 103. In step 201, the local disk array controller 104 of the local storage subsystem 103 receives the write request and in step 202, the local disk array controller 104 of the local storage subsystem 103 writes the I/O request, i.e., the data, to its non-volatile cache 105. In the art, a write to non-volatile cache is considered to mean that the data is now “safe,” and can be written out later to the disk as the disk rotates into position. Essentially simultaneously to step 202, the local disk array controller 104, in step 204, sends the write request to the remote storage subsystem 111. In step 205, the remote disk array controller 112 receives the request, and then, the remote disk array controller 112 writes the request to its cache 113 in step 206. As this is happening, in step 203, the local disk array controller 104 is copying the data from non-volatile cache 105 onto one or more HDDs 106. Once step 206 is complete, remote disk array controller 112 sends an acknowledgement to the local disk array controller 104 in step 208. In parallel, or soon thereafter, in step 207 the remote disk array controller 112 migrates the data from remote cache 113 to one or more HDDs 114. In step 210, the local disk array controller receives the acknowledgment from the remote disk array controller 112. Finally, the local disk array controller 104 sends an acknowledgment to the servers 101, such as a device end, of the write in step 210. In step 212, the server(s) 101 receives the acknowledgement and then continues processing. The architecture and method, as described, can be disadvantageous because using current technology and architecture, the maximum distance between the local site 100 and remote site 110 is approximately twenty-five miles. In addition the server(s) 101 waits for the local disk array controller 103 to return an acknowledgment to the server(s) 101 before server(s) 101 request another write I/O to the local storage subsystem 103. Thus, this method for data backup or storage can be time and/or resource inefficient. If the distance between the local and remote site is increased, then the server will have to account for and wait for a longer period of time for an acknowledgement before additional information can be written.

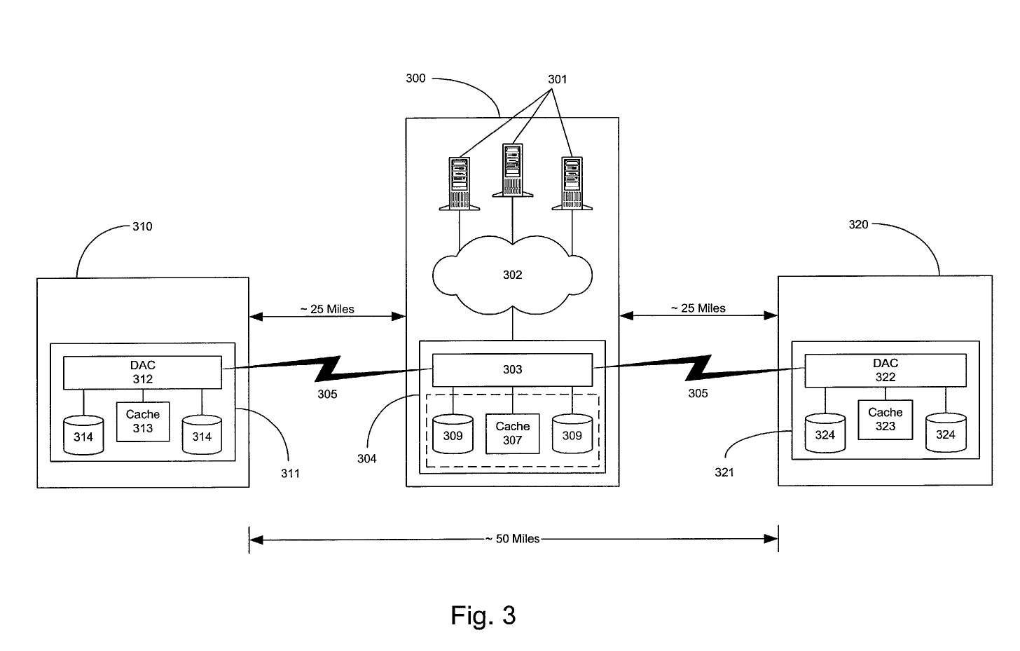

Reference is now made to FIG. 3, depicting a bipolar data mirroring architecture. The primary production site 300 is connected to the two remote sites 310, 320 by one or more networks 305. In one embodiment of the invention, a bipolar mirror controller (BMC) 303, connected to the server(s) 301 and/or optional SAN 302, is located at the primary production site 300. Each of the two remote sites 310, 320 include storage subsystems 311, 321, respectively. Each remote storage subsystem 311, 321 includes a disk array controller (DAC) 312, 322, cache 313, 323, and HDDs 314, 324, respectively. In another embodiment of the invention, not shown, the bipolar mirror controller 303 may be housed within the server(s) 301, or its functions may be performed by the server(s) 301.

In this embodiment of the present invention, only two remote sites are shown. It should be appreciated that more than two remote sites may be used to provide additional data continuity. The remote sites 310, 320 are optimally located diametrically opposed to each other, so as to maximize the separation between copies of the data for a given round-trip for a write-request-send and a write-request-acknowledgement. That is, at opposite poles. However, for purposes of this specification and claims, diametrically opposed means located at such an angle from the local site 300 that the remote sites 310, 320 are farther apart from each other than they are from the local site 300. For instance, one remote site 310 could be twenty-five miles east of the local site 300, while the other remote site 320 could be twenty-five miles west of the local site 300. This allows the maximum distance of separation of the two data mirrors to be no less than fifty miles, which greatly reduces the likelihood that a disaster will impact all data mirrors, without incurring additional delays that may be encountered by conventional methods. However, it is also possible that one remote site 310 could be twenty-five miles north of the local site 300, while the other remote site 320 could be twenty-five miles east of the local site 300. This architecture, while not providing the optimum distance separation of the remote sites as in the previous example, would still allow the remote sites to be located approximately at least thirty-five miles apart. This architecture also provides a clear upgrade path for existing mirroring customers, because the mirror site configurations are similar to those already in use.

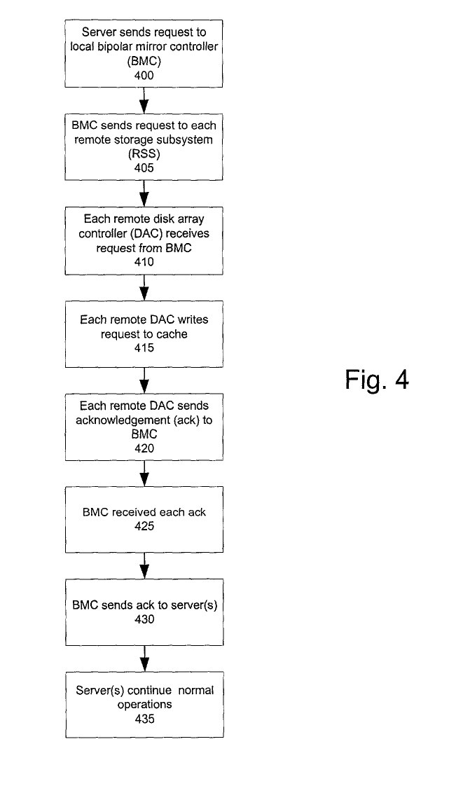

FIG. 4 depicts a flow chart of a bipolar synchronous mode data mirroring method. In step 400, the server(s) send a write I/O request to the local BMC 303. In step 405, the local BMC 303 sends the request to each of the remote storage subsystems 310, 320. Each remote DAC receives the request from the local BMC 303 in step 410, and each remote DAC writes the request to the cache in step 415. As in the prior art case, the remote DACs can then schedule an actual write for the very near term to one or more HDDs, i.e., migrate the data out of non-volatile cache 313, 323. In step 420, each remote DAC sends an acknowledgment to the local BMC 303, which is received in step 425. After receiving acknowledgments from each of the remote sites, in step 430 the BMC 303 sends an acknowledgement to the server(s) 301. In step 435, the server(s) 301 continue normal operations and are able to make additional write I/O requests.

In other embodiments of the present invention, additional components such as Storage Area Networks, dual caches, power supplies, network equipment, host bus adapters, storage subsystem data and/or control buses, and the like may be included (not shown). The connections between the disk array controllers' HDDs or other storage devices are logically shown, and in effect may occur across a single or dual bus.

In another embodiment, the above bipolar data mirror architecture includes local storage of either a cache, one or more HDDs, or both. The primary site 300 may include a modified local storage subsystem 304, including a bipolar mirror controller 303, optional cache 307, and optional HDDs 309. Upon receiving a write I/O from the server(s)s 301, in accordance with the invention, the bipolar mirror controller 303 may write the I/O to its cache 307 before sending requests to each of the remote storage subsystems 311, 321. This embodiment then follows the method as described with respect to FIG. 4. This embodiment may include local cache 307 and/or the local HDDs 309 for storage as well as at least two remote storage sites 310, 320, thus improving data continuity. An additional benefit from a performance perspective is that for read requests, the data is local. For variations of this embodiment where a balance is desirable between the cost of storage components, availability, and read performance, the local storage system can have limited storage to provide higher performance on read requests based on locality of reference for caching. Where read requests tend to be essentially random, and optimizing read performance is important, it may be desirable to increase the amount of local storage to be on par with that at the remote sites—where the primary function performed by the local storage is to service read requests, and the primary purpose of the remote storage is to maximize data availability. Many variations of this embodiment are intended to be covered within the scope of this invention. E.g., the local storage, which is oriented towards servicing reads, may not be locally mirrored, whereas remote storage, which is oriented towards maximally preventing data loss, may be mirrored “locally” within the remote site.

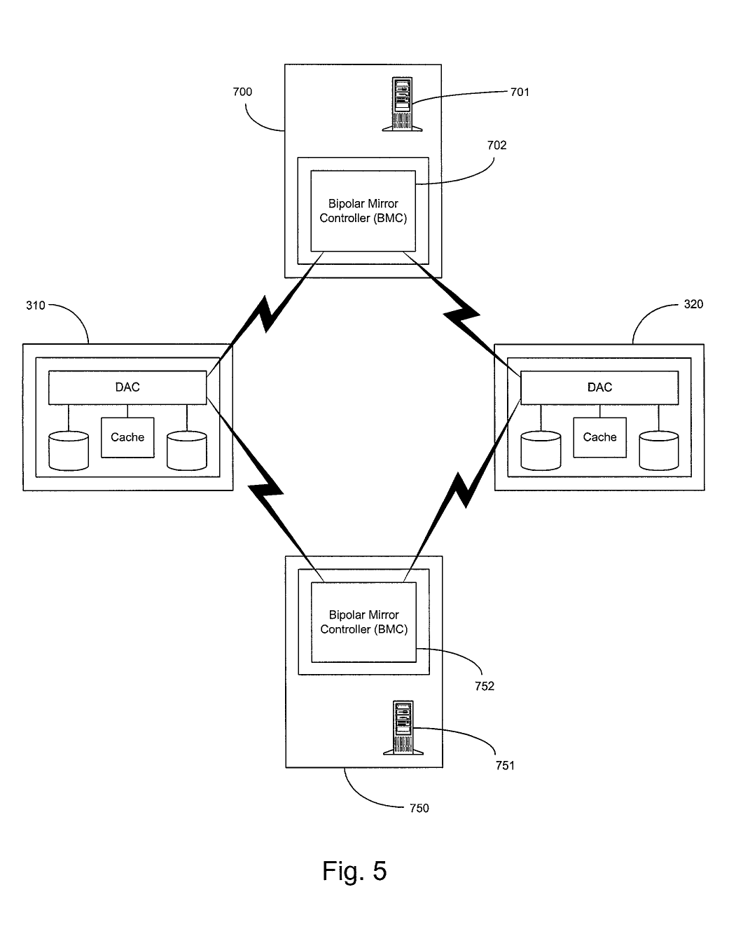

In another embodiment, FIG. 5 shows a dual ported bipolar server and data mirror architecture. This embodiment includes a primary production site 700, backup production site 750, and at least two remote mirror sites 310, 320. Each of the production sites 700, 750 includes server(s) 701, 751 and bipolar mirror controllers 702,752, respectively. Primary production site 700 is connected to and interacts with remote sites 310, 320 as discussed above with reference to FIGS. 3 and 4. In addition, backup production site 751 serves as a backup for the primary production site 700, in the event that primary production site 700 fails. Primary site 700 and backup site 750 may each include optional cache and HDDs (not shown), to provide additional data continuity and enhanced read I/O performance.

In an embodiment of the present invention, the backup site 750 may interact with the remote sites 310, 320 in the same manner as the primary site 700. This is desirable to maintain service in the event the primary site 700 experiences a failure.

In another embodiment of the present invention, at least one of the primary or backup sites 700, 750 includes a SAN (not shown).

The embodiment of the invention as shown in FIG. 5 is a highly reliable server and storage architecture that can tolerate a loss of either a server location or a storage location while maximizing distance for a given time budget for synchronous-mode remote mirroring. Throughout this disclosure, we have repeatedly referenced twenty five miles as a rule-of-thumb typically used in the industry, based on signal attenuation and timing standards in industry standards such as IBM's ESCON (Extended System Connectivity) protocol. However, it will be recognized that this distance will decrease as server clock speeds increase and increase as data communications equipment speeds increase. What is important, therefore, is not the current twenty-five mile rule of thumb, but rather the insight that the principles described in the embodiments of this disclosure can be used to increase the useful distances for synchronous mode mirroring up to two times the limitation as described above, and even further in the embodiments described below.

In another embodiment of the invention a wide-area storage cascade is used. The wide-area storage cascade provides a means of extending the distance by which a remote mirror can be located from a server by creating a cascade of intermediate relay and acknowledgment points. Using a wide-area cascade the risk of local or regional disasters, such as blackouts and floods, can be successfully mitigated by allowing remote sites to be placed a potentially unlimited geographic distance from the local site. In addition, because the relay point “mimics” the acknowledgement expected by the primary location, yet securely saves the data, data can by synchronously mirrored unlimited distances.

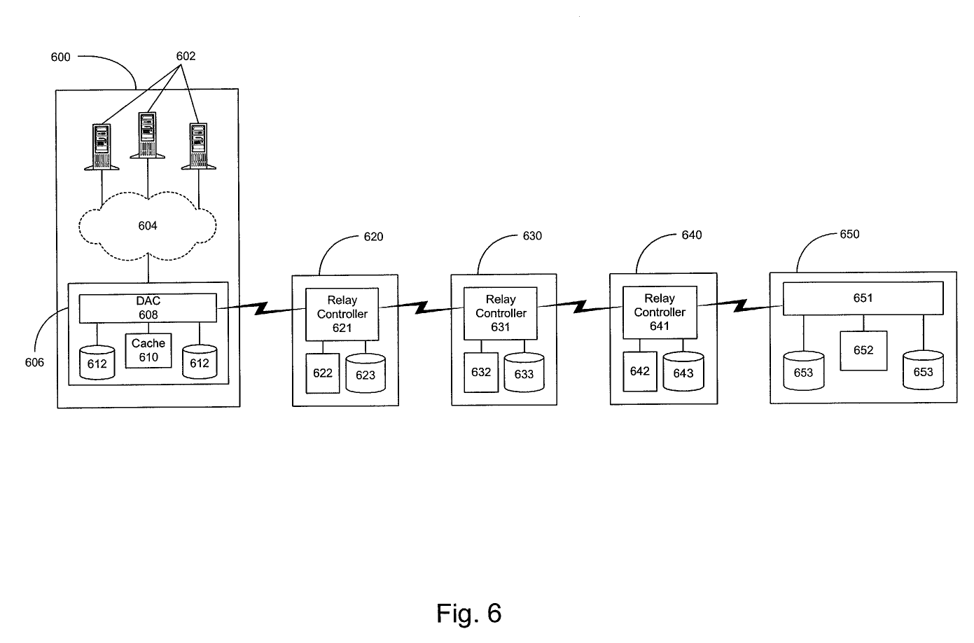

A wide-area cascade is now described with reference to FIG. 6. The local site 600 contains server(s) 602, an optional SAN 604, and a local storage subsystem 606. The local storage subsystem 606 contains a disk array controller 608, an optional cache 610, and optional HDDs 612. It should be noted that the cache 610 and the HDDs 612 are optional, as a bipolar wide-area cascade model could be used in conjunction with the above bi-polar embodiments, thus negating the need for local storage.

The local storage subsystem 606 is connected to a first relay 620. The first relay 620 is connected to a second relay 630. The second relay 630 is connected to a third relay 640. The third relay 640 is connected to a remote mirror site 650. It should be appreciated that while the present embodiment depicts three relays 620, 630, 640, greater or fewer numbers of relays may be used to increase or decrease the distance of the remote site from the local site, respectively. In the present embodiment, each relay is located approximately twenty-five miles from the previous relay or mirror site, thus supporting a 100-mile total distance from the local site 600 to the remote site 650. However, it is possible to place relays within any distance in which satisfactory performance is achieved, thus expanding or shortening the distance, depending on various factors discussed above.

Each of the relays 620, 630, 640 contain a relay controller 621, 631, 641, respectively. In addition, each relay 620, 630, 640 may contain an optional cache 622, 632, 642 and an optional storage device 623, 633, 643, respectively. In this manner, each relay could be an independent remote site, or may merely act as a relay station.

In the present embodiment, as each relay receives a write I/O request from the local site or previous relay, the relay immediately sends an acknowledgment to the previous relay or local site after writing the request to its cache, without waiting for acknowledgments from the remaining relays and/or remote site. Thus, the local DAC 608 will only wait for the acknowledgment from the first relay 620 to return to the local storage subsystem 606. The local DAC 608 will send the acknowledgment to the server(s) 602, allowing the server(s) to continue normal operation. Table 1 shows the sequence of events in the embodiment of FIG. 6, where relays are approximately 30 miles apart, and propagation speed is 5 microseconds/mile (150 microseconds/30 miles).

Table 1 is as follows:

| TIME | |
|---|---|
| (microseconds) | EVENT |
| 0 | Server 602 initiates a write transaction. |
| 5 | Local disk array controller (DAC) 606 begins local write, |
| | DAC 606 forwards the message to first relay 620 with |
| | write request. |
| 5-155 | Write request message travels to first relay 620. |
| 155 | First relay 620 receives write request. |
| 160 | First relay 620 saves the write in cache 622 (First relay |
| | 620 may also begin to perform the write on an optional |
| | hard disk 623) |
| | First relay 620 initiates write request message to second |
| | relay 630 |
| | First relay 620 sends acknowledgement to local DAC 606 |
| 160-310 | Acknowledgement travels “back” to local DAC 606. |
| | Write request travels “forward” to sxecond relay 630. |
| 310 | Acknowledgement received by local DAC 606. |
| | Write request is received by second relay 630. |
| 315 | Local DAC 606 returns a synchronous write acknowl- |
| | edgement to the server(s) 602). |
| | The primary DAC 606 discards the queue entry referring |
| | to the write request message. |
| | Second relay 630 saves write in cache 632 (second relay |
| | 630 may perform the write on an optional hard disk 633) |
| | Second relay 630 initiates write request message to third |
| | relay 640. |
| | Second relay 630 sends acknowledgement to first relay |
| | 620. |
| 320 | Server(s) 602 receives synchronous write commit. Ser- |
| | ver(s) 602 continues to process. |
| 315-455 | Acknowledgement travels “back” to first relay 620 from |
| | second relay 630. |
| | Write request travels “forward” to third relay 640 |
| | from second relay 630. |
| 455 | Third relay 640 receives write request. |
| | First relay 620 receives acknowledgement. |
| 460 | First relay 620 discards cache entry referring to acknowl- |
| | edged I/O. |
| | Third relay 640 saves write in cache (third relay 640 may |
| | perform the write on an optional hard disk 643) |
| | Third relay 640 initiates write request message to remote |
| | mirror 650. |
| | Third relay 640 sends acknowledgement to second relay |
| | 630. |
| 460-610 | Acknowledgement travels “back” to second relay 630 |
| | from third relay 640. |
| | Write request travels “forward” to remote mirror 650 |
| | from third relay 640. |
| 610 | Remote mirror 650 receives write request via remote |
| | DAC 651. |
| | Second relay 630 receives acknowledgement from third |
| | relay 640. |
| 615 | Second relay discards cache entry referring to acknowl- |
| | edged I/O. |
| | Remote DAC 651 saves write in cache 652 |
| | Remote DAC 651 writes to disk 653. |
| | Remote DAC 651 sends acknowledgement to third relay |
| | 640. |
| 615-765 | Acknowledgement travels “back” to third relay 640 |
| | from remote mirror 650. |
| 770 | Third relay 640 receives acknowledgement from remote |
| | mirror 650. |
| 775 | Third relay 640 discards cache entry referring to ack- |
| | nowledged I/O. |

This wide-area cascade architecture and technique allows the server(s) 602 to continue to process after 320 microseconds, whereas a conventional remote mirroring technique would require approximately 1200 microseconds for the request to travel 120 miles to the remote site and for the acknowledgment to travel 120 miles back to the primary site.

In another embodiment, a system requires that the write at the remote mirror site be acknowledged before the server continues processing. As in the above embodiment, the data write request moves from relay to relay until it reaches the remote site, however, an acknowledgement travels the entire round trip before the server receives the acknowledgement that the I/O has completed, i.e., that the data has been written to one or more remote sites. The cascade can work in this way, allowing applications to rapidly process a set of writes. Until the acknowledgment is received from the remote site, the set of writes are place in a “still executing” state. When the acknowledgment is received from the remote site, the set of writes are placed into a final “committed” state.

In the event of a local or regional disaster at the primary site, the data is safe in transit, as each relay and the remote site will continue to operate normally. In the event of a disaster breaking the link between the primary and remote sites, or in the event that the remote site is lost due to outage or disaster, the original data is safe, and a checkpoint and/or restart type of procedure would be used to bring alternate paths up, unless there were already one or more redundant paths to the remote mirror site. Many variations of disaster are possible, e.g., the fourth link in an 8 link cascade might be cut. Regardless of scenario, however, either the original data maintains its integrity, or a copy of the data will either exist immediately at the moment of the disaster, or shortly thereafter as it finishes traversing the cascade. In fact, even in more convoluted scenarios, such as the loss of a link segment AND the loss of the original copy of the data, once the segment is restored, data traversing “forward” through the cascade, and acknowledgements traversing “backward” through the cascade will restore the equilibrium.

Using wide-area cascades, data can be removed not only out of harms way, but also right up to the recovery site, so that the server can continue processing without any restart period. For example, several high availability architectures have active-active or active-passive pairs of servers. For example, the primary location may have an active server, and the recovery site or sister site, which is a secondary location into which data is mirrored, may have a server which is correctly configured, with all applications loaded, but not actually processing data. The servers at both sites maintain contact with each other, and should something happen to the primary site, the secondary site server detects this “instantly” and begins to run. This results in 24×7 server availability, but more importantly, provides continuity of the data processed by the servers, which might, e.g., have Internet auction bids. Finally, because the relay points are functional without disk storage associated with them, they are more inexpensive to manufacture and deploy than an architecture which would require data storage at each relay location.

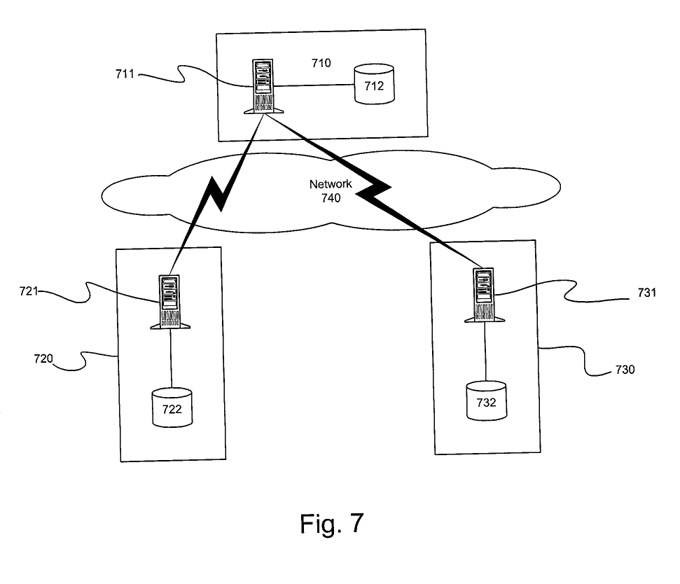

It should be appreciated that many variations of the principles of the invention disclosed herein are possible. For example, FIG. 7 shows an embodiment of bipolar mirroring without cache, a storage area network, or disk controller-level communications. Instead, referring to the diagram, each of primary site 710, first mirror site 720, and second mirror site 730, all contain a server with some direct attached storage. According to the principles of the invention, first mirror site 720 and second mirror site 730 may be located with the greatest possible geographical separation. Optionally, first mirror site 720 and second mirror site 730 may have, instead of a general-purpose server, a server dedicated to file system operations, such as a file server, or a so-called Network Attached Storage device, such as the “Filer” available from Network Appliance, Inc. Servers 711, 721, and 731 communicate with each other over network 740, which, e.g., may be an Internet Protocol network, using a variety of point-to-point (unicast) or multicast protocols. As shown, server 711 has storage direct attached to it, but this storage may in fact not exist, or may be attached via a SAN or a LAN (i.e., Network Attached Storage).

When an application (not shown) in server 711 desires to write to a file, the file system software (not shown) in server 711, operating under the principles of the invention described earlier with respect to FIGS. 3 and 4, sends a write request over network 740 to servers (or filers) 721 and 731. Optionally, the data can be written to storage device 712, should it be present. Such a request may be sent as two user datagrams over network 740, as one multicast datagram with destination addresses of servers 721 and 722, or within two reliable transport layer sessions running between servers 711 and 721 and between 711 and 731 respectively.

Servers (or filers) 721 and 731 then write the data in the request to their storage devices 722 and 732 respectively. It will be appreciated that many variations are possible here, e.g., storage device 722 may be a so called silicon disk, a CD-ReWritable drive (CDRW), a floppy disk, a RAID array, either direct attached, network attached, or over a point-to-point storage area network or a switched mesh network or the like.

When the write has been completed, servers 721 and 731 send an acknowledgement message back to the aforementioned file system software in server 711, which then synchronously returns control to the application. Optionally, such writes may be performed asynchronously, in which case the application would have continued to process while the aforementioned was proceeding.

From the foregoing, it will be appreciated that many variations and modifications may be made without departing from the spirit and scope of the novel concepts of the subject invention. It is to be understood that no limitation with respect to the specific apparatus and methods illustrated here are intended or should be inferred.

I/We claim:

1. A data mirroring system, comprising:
a local site at a first location comprising:
a server; and
a mirror controller; and
at least two remote mirror sites, each at different geographic locations, wherein each location is other than the first location, and wherein each remote mirror site comprises:
a disk array controller; and
means for storing data;
wherein said local site is communicatively coupled to each remote mirror site.

2. The system of claim 1, wherein each of said at least two remote mirror sites further comprise a cache.

3. The system of claim 1, the local site further comprising:
a storage area network (SAN).

4. The system of claim 1, the local site further comprising:
a cache; and
means for storing data.

5. The system of claim 1, wherein at least one of said at least two remote sites is geographically displaced at least twenty-five miles from the local site.

6. The system of claim 1, wherein said at least two remote sites further comprising exactly two remote sites.

7. The system of claim 6, wherein said remote sites are substantially diametrically opposed to each other, and said remote sites are geographically located at least approximately 25 miles apart.

8. The system of claim 1, further comprised of:
a backup site comprising a backup mirror controller and a backup server, and adapted to being operational when the local site ceases normal functions.

9. The system of claim 8, said backup site further comprising:
a cache; and
a means for data storage.

10. A method of data mirroring to insure the continuity of data, said method comprising the steps of:
(i) receiving a data write request at a primary mirror controller;
(ii) sending the data write request to each of at least two remote mirror sites;
(iii) receiving an acknowledgement message (ACK) from each remote mirror site, wherein each ACK comprises information that the data write request has been received and executed by the remote mirror site for which the ACK corresponds; and
(iv) sending an ACK that the data write request has been completed.

11. The method of claim 10, wherein each of said remote mirror sites is adapted to write the data write request to a cache and to a remote storage means.

12. The method of claim 10, further comprising the steps of:
(v) upon completion of step (i), writing the data write request to a cache connected to the primary mirror controller; and
(vi) upon the completion of step (iii), removing the data write request from the cache connected to the mirror controller.

13. The method of claim 10, further comprising the steps of:
(v) detecting an interruption of service by the primary mirror controller;
(vi) switching to a secondary mirror controller;
(vii) performing steps (i)-(iv) substituting the secondary mirror controller in place of the primary mirror controller.

14. A wide-area cascade system for data mirroring, comprising:
a local site adapted to generate a data write request;
a remote mirroring site adapted to accept and perform said data write request; and
a relay chain comprising at least one relay point, said relay chain located between said local site and said remote mirroring site, said relay point(s) adapted to forward the data write request(s) to one of the next relay point or the remote site, and to send an acknowledgment message back to one of the previous relay or the local site.

15. The system of claim 14, wherein the local site is comprised of:
a server adapted to generate said data write request;
a storage subsystem comprising:
a disk array controller adapted to receive the data write request from the server and to forward the data request to the first relay.

16. The system of claim 15, wherein the storage subsystem further comprises:
a cache; and
a means for storing data;
wherein said disk array controller being further adapted to write the data write request to the cache and to perform the data write request on the means for storing data.

17. The system of claim 14, wherein the remote site comprises:
a cache;
means for storing data;
a remote disk array controller adapted to receive the data write request from the relay immediately preceding the remote site, to write the data write request to the cache, and to perform the data write request on the means for storing data.

18. The system of claim 14, wherein at least one of the at least one relays comprises:
a cache;
a means for storing data;
a relay disk array controller, adapted to receive the data write request(s) from the local site, to write the data write requests to the cache, to forward the data write request(s) to one of the next relay or the remote site, and to perform the data write requests on the means for storing data.

19. A method of mirroring data, comprising the steps of:
(i) generating a data write request at a local site;
(ii) sending the data write request through a relay system comprised of at least one relay point;
(iii) receiving the data write request at a remote mirror site;
(iv) writing the data write request to a memory; and
(v) sending an acknowledgement message to the relay system.

20. The method of claim 19, wherein each of said at least one relay point performs the steps of:
(a) writing the data write request to a relay point cache;
(b) sending an acknowledgment message back to one of a previous relay point and the local site; and
(c) sending the data write request to one of a next relay point and a remote mirror site.

21. The method of claim 20, further including the step of removing the data write request from each relay point cache as each relay receives the acknowledgment message.
